(19) United States
(12) Patent Application Publication
(10) Pub. No.: US 2013/0187852 A1
(43) Pub. Date: Jul. 25, 2013

(54) THREE-DIMENSIONAL IMAGE PROCESSING APPARATUS, THREE-DIMENSIONAL IMAGE PROCESSING METHOD, AND PROGRAM

(71) Applicants: Akihiro Ebina, Kyoto (JP); Seiji Kubo, Osaka (JP); Mariko Murakami, Osaka (JP)

(72) Inventors: Akihiro Ebina, Kyoto (JP); Seiji Kubo, Osaka (JP); Mariko Murakami, Osaka (JP)

(21) Appl. No.: 13/598,145

(22) Filed: Aug. 29, 2012

(30) Foreign Application Priority Data
Jan. 19, 2012 (JP) 2012-008860
Jul. 13, 2012 (JP) 2012-158101

(51) Int. Cl. G06F 3/033

(52) U.S. Cl. 345/158

(57) ABSTRACT

A three-dimensional image processing apparatus includes: an output unit configured to output a plurality of three-dimensional images to a display apparatus; a detection unit configured to detect a pointer in association with a three-dimensional image displayed on the display apparatus; an operation determination unit configured to determine a predetermined operation based on movement of the pointer detected by the detection unit; and an image processing unit configured to perform, on the three-dimensional image associated with the pointer, processing associated with the predetermined operation determined by the operation determination unit, and to cause the output unit to output the processed three-dimensional image.

### CROSS REFERENCE TO RELATED APPLICATIONS

The present application is based on and claims priority of Japanese Patent Applications No. 2012-008860 filed on Jan. 19, 2012 and No. 2012-158101 filed on Jul. 13, 2012. The entire disclosures of the above-identified applications, including the specifications, drawings and claims are incorporated herein by reference in their entirety.

### TECHNICAL FIELD

The present invention relates to three-dimensional image processing apparatuses for space-operating three-dimensional (3D) objects displayed on a display apparatus in accordance with a viewpoint position of a user.

### BACKGROUND ART

Conventionally, a terminal apparatus through which a set item displayed on a screen can be operated in space is available.

For example, Patent Literature (PTL) 1 discloses an apparatus through which a set item displayed on a screen can be operated in space. Specifically, this is an apparatus for spatially operating the set item displayed on the screen and a set value of the set item, by detecting space coordinates of a finger which is operating the set item.

Furthermore, it is described that the display apparatus in PTL 1 allows a user to adjust the set value of the set item, simply by making a finger closer to or further from the operation surface, by using distance information between the finger of the user and the operation surface.

### CITATION LIST

### Patent Literature

[PTL 1] Japanese Unexamined Patent Application Publication No. 2011-118511

### SUMMARY OF INVENTION

### Technical Problem

However, the display apparatus disclosed in PTL 1 is not based on the premise that the apparatus is used by a plurality of users. In other words, errors may occur when each of the users try to operate the display apparatus.

The present invention has been conceived in view of the above problem and has an object to provide a three-dimensional image processing apparatus which can appropriately reflect each of operations performed by a plurality of users to a three-dimensional image in association with the user.

### Solution to Problem

A three-dimensional image processing apparatus according to an aspect of the present invention causes a display apparatus to display a three-dimensional image, the display apparatus being capable of separately displaying a plurality of three-dimensional images. Specifically, the three-dimensional image processing apparatus includes: an output unit configured to output a plurality of three-dimensional images to the display apparatus; a detection unit configured to detect a pointer in association with a three-dimensional image displayed on the display apparatus; an operation determination unit configured to determine a predetermined operation based on movement of the pointer detected by the detection unit; and an image processing unit configured to perform, on the three-dimensional image associated with the pointer, processing associated with the predetermined operation determined by the operation determination unit, and to cause the output unit to output the processed three-dimensional image.

It is to be noted that a general or specific aspects of the above may be realized by a system, a method, an integrated circuit, a computer program, or a recording medium, and an arbitrary combination of a system, a method, an integrated circuit, a computer program, or a recording medium.

### Advantageous Effects of Invention

With the present invention, an operation performed by each of users is reflected to a three-dimensional image in association with the user. Therefore, a three-dimensional image processing apparatus can be provided which allows each of users to perform space-operation without having feeling of strangeness.

### BRIEF DESCRIPTION OF DRAWINGS

These and other objects, advantages and features of the invention will become apparent from the following description thereof taken in conjunction with the accompanying drawings that illustrate a specific embodiment of the present invention. In the Drawings:

FIG. 1 shows a mechanism of a display for three-dimensional display;

FIG. 2 shows a relationship of projected amount of a 3D object;

FIG. 3 shows an example of a space-operation of the 3D object;

FIG. 4 shows an example of operations from a plurality of viewpoints;

FIG. 5 shows a general configuration of a tablet apparatus according to Embodiment 1;

FIG. 6 shows a functional block of a signal processing unit according to Embodiment 1;

FIG. 7 shows a schematic diagram showing circumstances around the tablet apparatus;

FIG. 8 shows an example of video captured by a camera;

FIG. 9 shows space coordinates according to Embodiment 1;

FIG. 10 shows a display information table according to Embodiment 1;

FIG. 11 shows output result of user position finger coordinate calculation unit according to Embodiment 1;

FIG. 12 is a flowchart of selection operation according to Embodiment 1; and

FIG. 13 shows a usage example of a tablet apparatus according to Embodiment 2.

### DESCRIPTION OF EMBODIMENTS

### [Observation Formed the Basis for the Present Invention]

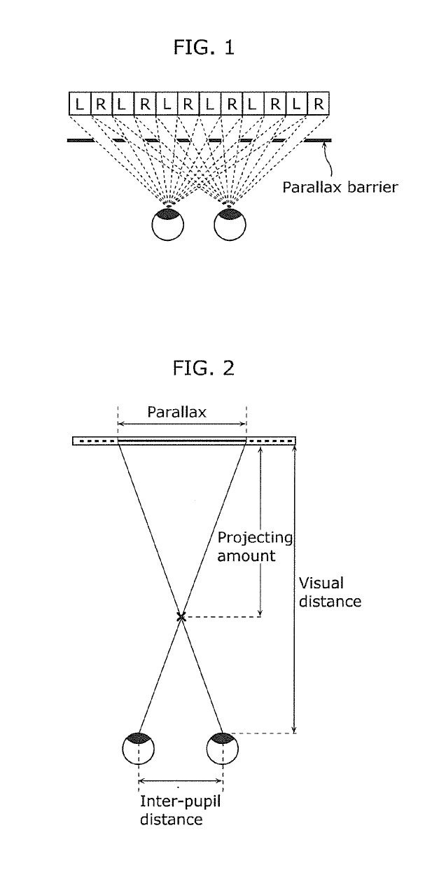

A general mechanism of a method for space-operating a 3D object displayed for naked-eye three-dimensional multi view is described. FIG. 1 describes a parallax barrier method which is one of mechanisms of a display for three-dimensional display. In order to provide a three-dimensional feeling and duplicate a three-dimensional video in the brain of human being, it is required to show video of different viewpoints to the right eyesight and the left eyesight of human being.

In the parallax barrier method shown in FIG. 1, a slit (parallax barrier) is arranged at a front surface of a display so that users can see specific pixels only from a specific direction. Thus, it is possible to show different videos to the right eyesight and the left eyesight. Other methods for showing different videos to the right eyesight and the left eyesight include a method for showing video of each pixel only in a specific direction using lenticular lens (lenticular lens method).

Although the parallax barrier method shown in FIG. 1 is for three-dimensional display from one viewpoint, a naked-eye multi-viewpoint display for an increased number of viewpoints also exists. In the naked-eye multi-viewpoint display, a slit (parallax barrier) is arranged so that the users can see a specific pixel for each specific viewpoint.

FIG. 2 shows a relationship among a projected amount of a three-dimensional object, visual distance, inter-pupil distance, and parallax. The visual distance is uniquely defined based on the performance of the parallax barrier. Specifically, a position from which a user generally views video is fixed depending on a size of the display and the like. Therefore, it is sufficient to design intervals between the slits of the parallax barrier. Furthermore, as to the inter-pupil distance, a general interval between pupils of adults, namely 6 cm, may be adopted as the inter-pupil distance, a set value of the inter-pupil distance may be preliminarily input, or the inter-pupil distance of the user may be measured by a camera or the like. No matter how the inter-pupil distance is determined, the inter-pupil distance is a predetermined parameter. In other words, it is possible to obtain the projected amount of the 3D object uniquely, based on the parallax displayed on the display.

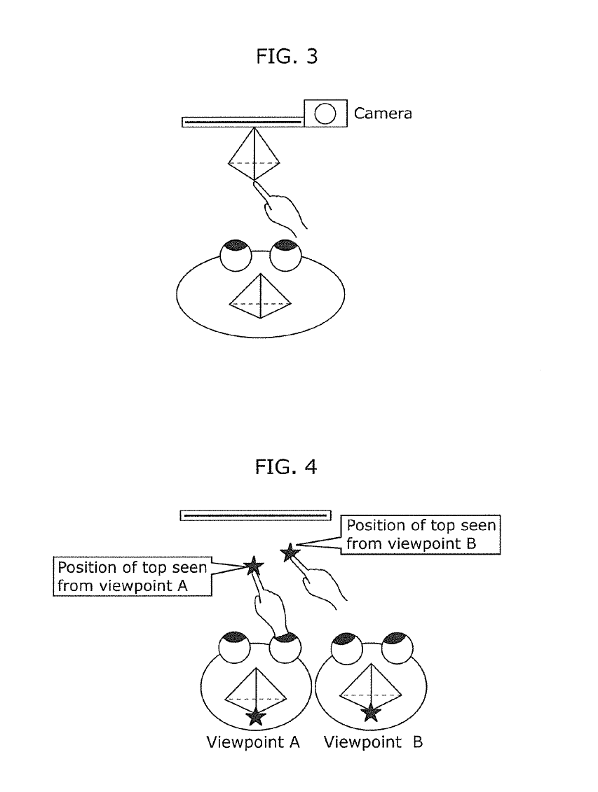

FIG. 3 is a conceptual diagram for the case where “selection”, which is an example of the space-operation on the 3D object displayed for naked-eye three-dimensional multi view, is performed. A spatial position of the 3D object in a triangular pyramid can be identified based on the above described mechanism of the parallax barrier method and a parallax amount. Furthermore, by further analyzing the image using a sensing device such as a camera, a position of a finger of the user can be detected. In addition, by performing a comparison test on a projected position of the 3D object and the position of the finger of the user, the selection operation of the 3D object can be performed.

As described above, in the method for space-operating a 3D object which is displayed for naked-eye three-dimensional multi view, by using the distance information between the finger of the user and the 3D object displayed for three-dimensional view, as disclosed in PTL 1, a virtual object displayed with projected into space can be selected as if the object actually existed.

However, PTL 1 does not take a case where a plurality of users operate 3D objects each displayed in a corresponding one of a plurality of viewpoints into consideration. Accordingly, in such a case, it is sometimes difficult for the users to perform operation by simply using the distance information of the finger of the user. FIG. 4 shows an example of operations from a plurality of viewpoints.

In the example in FIG. 4, the identical three-dimensional view diagram is displayed so that the three-dimensional view diagram can be seen in the same direction from Viewpoint A and Viewpoint B, using the naked-eye multi-viewpoint display which covers two viewpoints. By displaying the identical three-dimensional view diagram to be seen in the same direction from Viewpoint A and Viewpoint B, the user at Viewpoint B can share the identical three-dimensional view diagram as the user at Viewpoint A is seeing.

If the conventional space-operation is to be applied when the identical three-dimensional view diagram is seen in the same direction from Viewpoint A and Viewpoint B, there is a problem that the selection operation cannot be performed well because even when the user at Viewpoint A places a finger over a position where no three-dimensional view diagram exists for the user at Viewpoint A, the three-dimensional view diagram which the user at Viewpoint B is seeing may be selected.

For example, when the users try to select a top, which is appearing closest to the users, of the three-dimensional view diagram, the position selected by the user at Viewpoint A and the position selected by the user at Viewpoint B are different. Therefore, when the conventional space-operation is applied, there is a problem that, though it appears to the user at Viewpoint A that nothing is displayed on the position at which the three-dimensional view diagram for the user at Viewpoint B is displayed, when the user at Viewpoint A points a finger over a position on the three-dimensional view diagram displayed for the user at Viewpoint B, the user at Viewpoint A may perform a selection operation on the three-dimensional view diagram displayed for the user at Viewpoint B.

In order to solve the above problem, a three-dimensional image processing apparatus according to an aspect of the present invention causes a display apparatus to display a three-dimensional image, the display apparatus being capable of separately displaying a plurality of three-dimensional images. Specifically, the three-dimensional image processing apparatus includes: an output unit configured to output a plurality of three-dimensional images to the display apparatus; a detection unit configured to detect a pointer in association with a three-dimensional image displayed on the display apparatus; an operation determination unit configured to determine a predetermined operation based on movement of the pointer detected by the detection unit; and an image processing unit configured to perform, on the three-dimensional image associated with the pointer, processing associated with the predetermined operation determined by the operation determination unit, and to cause the output unit to output the processed three-dimensional image.

With the above configuration, an operation by the user can be appropriately reflected to the three-dimensional image in association with the user, so that the three-dimensional image processing apparatus with higher operability can be obtained. It is to be noted that the “pointer” in the present description includes a hand or a finger of the user, and anything by which the user can perform the predetermined operation such as an indicating bar or a marker held by the user. Furthermore, “operation” in the present description represents, for example, selecting, rotating, moving, zooming in, and zooming out the three-dimensional image.

As an example, the operation determination unit may determine, as the predetermined operation, placement of the pointer over an arbitrary position in the three-dimensional image associated with the pointer. The image processing unit may perform processing on the three-dimensional image associated with the pointer to allow a user to perceive that the position over which the pointer is placed is selected.

“To allow a user to perceive that the position over which the pointer is placed is selected” in the present description means that, for example, performing image processing such as changing the color of, flashing, changing the brightness of, or highlighting the selected position.

As another example, the operation determination unit may determine, as the predetermined operation, movement of the pointer in an arbitrary direction at a position facing the three-dimensional image associated with the pointer. The image processing unit may perform processing on the three-dimensional image associated with the pointer so that the three-dimensional image rotates in a direction of the movement of the pointer.

For example, the display apparatus may display a plurality of identical three-dimensional images. The image processing unit may further perform the processing associated with the predetermined operation determined by the operation determination unit on the three-dimensional image other than the three-dimensional image associated with the pointer, and cause the output unit to output the processed three-dimensional images.

Furthermore, the display apparatus may be capable of separately displaying each of the three-dimensional images in a corresponding one of a plurality of viewpoint regions. The output unit may output each of the three-dimensional images for the corresponding one of the viewpoint regions to the display unit. The detection unit may detect the pointer from each of the viewpoint regions and associate the detected pointer with the three-dimensional image in the viewpoint region from which the pointer is detected.

However, the present invention is not determined by the above, and can be applied to a case where the user and the user viewpoint position are detected first and a three-dimensional image is displayed in each detected viewpoint position.

A three-dimensional image processing method according to an aspect of the present invention is a method for causing a display apparatus to display a three-dimensional image, the display apparatus being capable of separately displaying a plurality of three-dimensional images. Specifically, the three-dimensional image processing method includes: outputting a plurality of three-dimensional images to the display apparatus; detecting a pointer in association with a three-dimensional image displayed on the display apparatus; determining a predetermined operation based on movement of the pointer detected in the detecting; and performing, on the three-dimensional image associated with the pointer, processing associated with the predetermined operation determined in the determining, and causing the processed three-dimensional image to be output in the outputting.

A program according to an aspect of the present invention is for causing a computer to cause a display apparatus to display a three-dimensional image, the display apparatus being capable of separately displaying a plurality of three-dimensional images. Specifically, the program includes: outputting a plurality of three-dimensional images to the display apparatus; detecting a pointer in association with a three-dimensional image displayed on the display apparatus; determining a predetermined operation based on movement of the pointer detected in the detecting; and performing, on the three-dimensional image in association with the pointer, processing associated with the predetermined operation determined in the determining, and causing the processed three-dimensional image to be output in the outputting.

### Embodiment 1

The following describes a tablet apparatus which is an example of the three-dimensional image processing apparatus according to the present embodiment, with reference to the drawings. It is to be noted that each of the embodiments described below is a preferable specific example of the present invention. Numeric values, shapes, materials, constituents, positions and topologies of the constituents, steps, an order of the steps, and the like in the following embodiments are an example of the present invention, and it should therefore not be construed that the present invention is determined by these embodiments. Furthermore, out of the constituents in the following embodiments, the constituents not stated in the independent claims describing the broadest concept of the present invention are described as optional constituents.

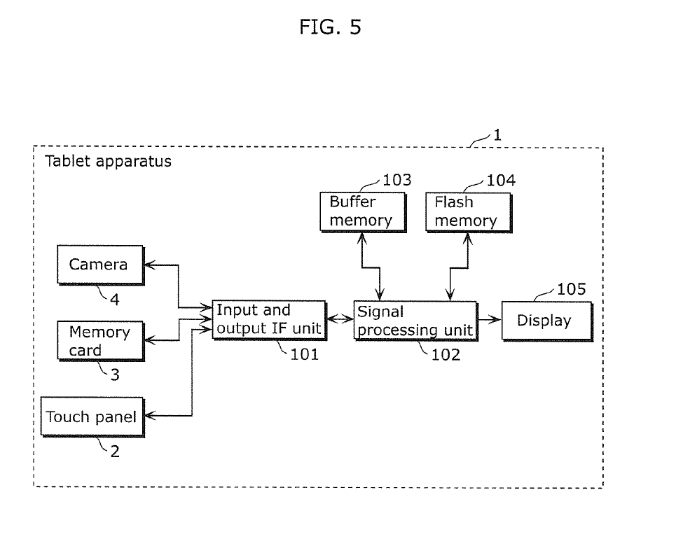

FIG. 5 shows a general configuration of a tablet apparatus which is an example of the three-dimensional image processing apparatus according to Embodiment 1. As shown in FIG. 5, a tablet apparatus 1 includes a touch panel 2, a memory card 3, a camera 4, an input and output IF unit (input and output interface unit) 101, a signal processing unit 102, a buffer memory 103, a flash memory 104, and a display 105.

The touch panel 2 is arranged on a front surface or the like of the display 105 of the tablet apparatus 1, and is an input apparatus through which the tablet apparatus 1 can be operated by pressing a screen of the display 105.

The memory card 3 is a recording medium for accumulating information required by various applications started on the tablet apparatus 1. The memory card 3 includes, for example, a semiconductor recording element.

The camera 4 is for capturing the user. The camera 4 includes, for example, an imaging element such as a CMOS sensor.

The input and output IF unit 101 is an interface through which device apparatuses such as the touch panel 2, the memory card 3, and the camera 4 can be connected. The input and output IF unit 101 makes it possible to transmit and receive a control signal and a data signal between the signal processing unit 102 and the device apparatuses. Specifically, the input and output IF unit 101 receives, as input information, a coordinate signal of a position at which the user pressed the touch panel 2, a video signal from the camera 4, and the information on various applications from the memory card 3, and transmit them to the signal processing unit 102. Furthermore, the input and output IF unit 101 receives, from the signal processing unit 102, the information outputted from the various applications, and transmits the information to the memory card 3 so that the information is recorded.

For example, the input and output IF unit 101 is realized by a memory card slot, a USB connector, or the like. Although the input and output IF unit 101 is shown as one block in FIG. 5, a card slot for the memory card 3 and a USB connector for the camera 4 may be provided separately. Simply put, the input and output IF unit 101 may have any configuration as long as an interface with the device apparatuses is realized.

The signal processing unit 102 controls the entire tablet apparatus 1. The signal processing unit 102 especially controls the camera 4 via the input and output IF unit 101. Moreover, the signal processing unit 102 performs image processing on the video signal obtained by the camera 4. An example of the control of the camera 4 performed by the signal processing unit 102 includes: controlling a power source; changing the size of the obtained image; changing the frame rate; and adjusting the white balance. It is to be noted that control of the camera 4 performed by the signal processing unit 102 is not determined by the above control, and may include any control to the camera 4.

Moreover, the signal processing unit 102 serves as a detection unit which detects (calculates) viewpoint positions of one or more users in association with position information of one or more hands (an example of the pointer) of the user, based on the video signal obtained by the camera 4.

As to the user viewpoint position, the signal processing unit 102 may identify the user viewpoint position by performing (i) image matching processing using a preliminarily prepared template indicating a form of a human being or (ii) image recognition in which a feature point is caught such as face recognition, on the entire video signal obtained by the camera 4. The signal processing unit 102 can further associate the identified user viewpoint position with the position information of the hand, by performing the image matching processing using a preliminarily prepared template indicating a form of neck, torso, arm, hand, and the like.

Furthermore, the position information of hand is given as x-y-z space coordinates having the origin at an arbitrary point in the real space spreading in front of the display 105, based on the video signal obtained by the camera 4. The distance information from the display 105 to the hand can be obtained by a stereo camera or by a three-dimensional distance image sensor which uses infrared rays. Thus, the signal processing unit 102 can detect the viewpoint positions of the one or more users associated with the position information of the one or more hands of the user, based on the video signal obtained by the camera 4.

The viewpoint positions of the one or more users associated with the position information of the one or more hands of the user can be detected more easily by fixing operation positions of the users and making each of the users to put a marker with a different color on the tip of a finger.

Specifically, when two users are viewing the display 105 of the tablet apparatus 1, one user views the display from the front with a blue marker put on a finger, while the other user views the display from a position that is diagonally right with a red marker put on a finger. Thus, the viewpoint position of the user associated with the position information of the hand of the user can be detected simply by extracting each of the red color and the blue color of the markers from the entire video signal obtained by the camera 4.

In other words, the position of the blue marker can be determined as the position information of the hand of the user at the viewpoint position in front, and the position of the red marker can be determined as the position information of the hand of the user at the viewpoint position that is diagonally right. As to the distance information of the hand, it is easy to identify the distance information based on the size of the area obtained by extracting the color.

Furthermore, the signal processing unit 102 serves as an image processing unit which generates a plurality of three-dimensional view images (hereinafter also referred to as “three-dimensional image”). The three-dimensional view image may be, for example, an image in which a parallax is generated by capturing a target object preliminarily displayed using two cameras set at different positions. Alternatively, the three-dimensional view image may be an image obtained by viewing, from two different viewpoints, an object which is virtually crated in a computer using, for example, three-dimensional object data called polygon data or texture data, such as the three dimensional computer graphics (CG). It is to be noted that a specific example of method of displaying the three-dimensional view image is not determined by the above and any method by which the user can have a three-dimensional sense may be adopted.

Furthermore, upon generating the three-dimensional view image, the signal processing unit 102 calculates the projected amount of the displayed image based on the visual distance, the inter-pupil distance, and the parallax amount. The signal processing unit 102 also serves as an output unit which outputs the generated three-dimensional view images to the display 105.

Moreover, the signal processing unit 102 serves as an operation determination unit which determines whether or not the hand of the user has contacted the three-dimensional view image in space, based on the viewpoint positions of the one or more users, the position information of the one or more hand of the user, and the projected amount of the generated three-dimensional view image.

The signal processing unit 102 above may be configured with, for example, a microcomputer or a hard-wired circuit.

The buffer memory 103 is used as a working memory, in signal processing performed by the signal processing unit 102. The buffer memory 103 is realized by, for example, a DRAM.

The flash memory 104 stores an operating system and a program which are executed by the signal processing unit 102. The flash memory 104 also stores information for generating the three-dimensional view image to be displayed on the display 105.

The display 105 displays the three-dimensional view image generated by the signal processing unit 102. The display 105 is, for example, a naked-eye multi-viewpoint display realized by the parallax barrier method or the lenticular lens method.

The following describes a specific configuration of the signal processing unit 102 with reference to the drawings.

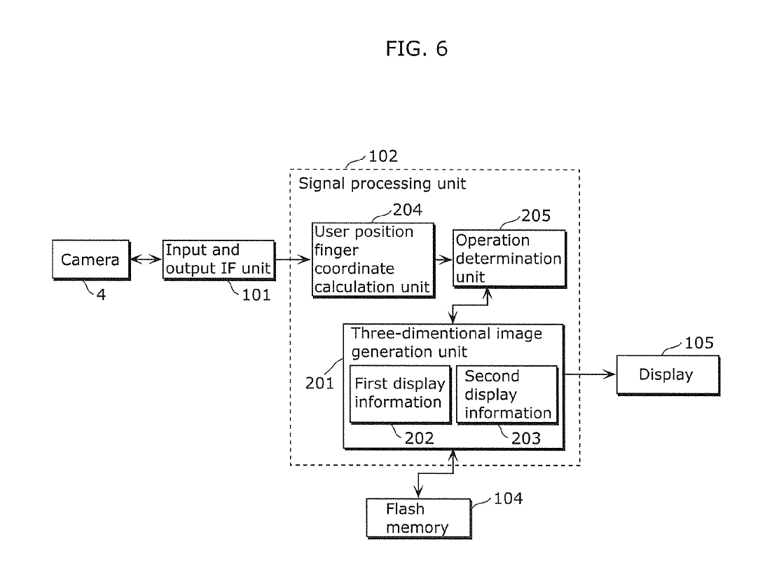

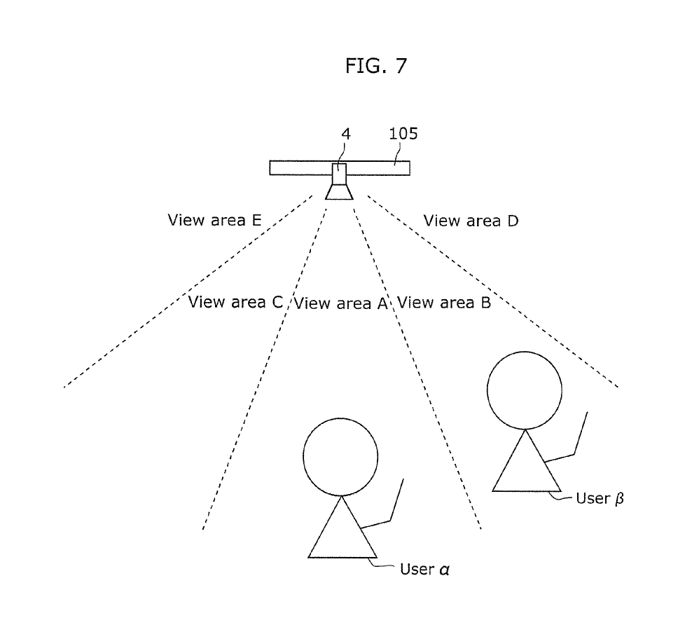

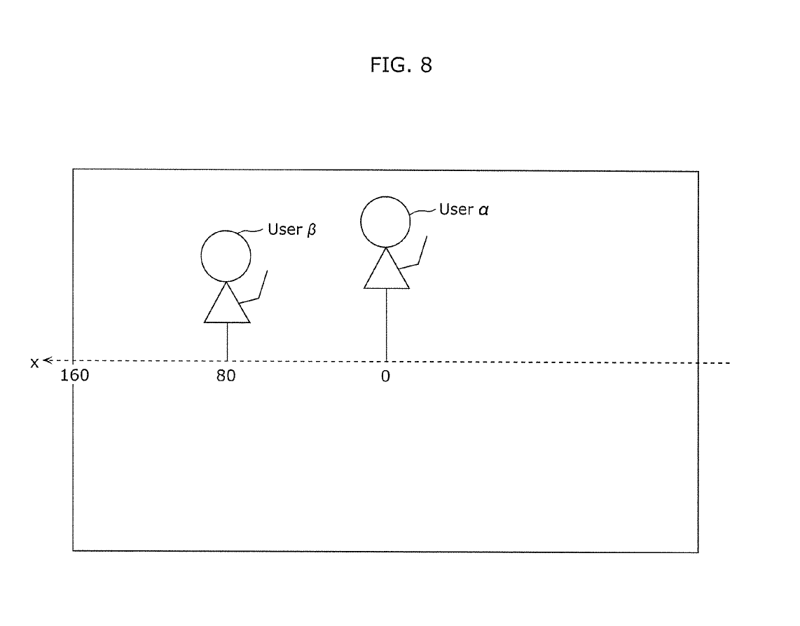

FIG. 6 shows a functional block of the signal processing unit 102. FIG. 7 shows a schematic diagram showing circumstances around the tablet apparatus 1. FIG. 8 shows an example of video captured by the camera 4.

As shown in FIG. 6, the signal processing unit 102 includes a three-dimensional image generation unit 201, a user position finger coordinate calculation unit 204, and an operation determination unit 205. The following describes the function of each constituent shown in FIG. 6, based on a case where two users, namely a user α and a user β, use the tablet apparatus 1 as shown in FIG. 7.

First, as shown in FIG. 7, space in front of the tablet apparatus 1 (space from which the user can see the display 105) is divided into a plurality of viewpoint regions, namely Viewpoint regions A, B, C, D, and E. Although Viewpoint regions A to E shown in FIG. 7 are divided by a virtual line which is radially extended from the center of the display 105, it is not limited to the above. In the example shown in FIG. 7, the user α is in Viewpoint region A and the user β is in Viewpoint region B.

The three-dimensional image generation unit 201, which serves as the image processing unit and the output unit, generates each of the three-dimensional images for the corresponding one of the viewpoint regions, and outputs the three-dimensional image to the display 101. More specifically, the three-dimensional image generation unit 201 generates a three-dimensional view image when an icon of an application for displaying three-dimensional view images is selected by an operation performed by a user on the touch panel 2, for example. Specifically, the three-dimensional image generation unit 201 reads the three-dimensional view image stored in the flash memory 104 and displays the three-dimensional view image on the display 105.

Here, description is provided based on an example where (i) the three-dimensional object data called polygon data or texture data, such as the three dimensional computer graphics (CG), is stored in the flash memory 104 and (ii) a three-dimensional view image is displayed on the naked-eye multi-viewpoint display for two viewpoints. The naked-eye multi-viewpoint display for two viewpoints separately displays, for example, a three-dimensional view image seen from the front of the display (Viewpoint region A in FIG. 7) and a three-dimensional view image seen from a position which is at a 45 degrees angle from the front of the display (Viewpoint region B in FIG. 7).

In other words, after obtaining three-dimensional object data from the flash memory 104, the three-dimensional image generation unit 201 draws a three-dimensional view image virtually based on the three-dimensional object data, on a graphic memory (provided within the three-dimensional image generation unit 201 and not shown in the drawing), using an API for drawing such as OpenGL (registered trademark). Moreover, the three-dimensional image generation unit 201 (i) defines, as a front image, an image obtained by seeing the virtually drawn three-dimensional view image from a first viewpoint (viewpoint from the user α in FIG. 7) and (ii) generates, as a parallax image for the front, a right-eye image and a left-eye image for the first viewpoint.

As to generation of a parallax image, a parallax image in which the projected amount can be identified is generated by, for example, preliminarily setting (i) the optimal viewing distance for the naked-eye multi-viewpoint display (30 cm, for example) and (ii) the inter-pupil distance of the user (6 cm, for example). The following specifically describes the above using an example. When OpenGL (registered trademark) is used, the projected amount of each top and each surface of the virtually drawn three-dimensional view image in real space can be grasped by (i) setting two virtual cameras with 6 cm of interval therebetween, at the viewpoint position which is 30 cm away from the three-dimensional view image virtually drawn on the graphic memory and (ii) generating a parallax image using the images obtained by the two cameras as a right-eye image and a left-eye image.

In the same manner, a parallax image in association with the second viewpoint (viewpoint of user β in FIG. 7) can also be generated. The second viewpoint is in the right of the first viewpoint by 45 degrees.

The following describes an example where the tablet apparatus 1 separately displays each of the three-dimensional view images in Viewpoint region A and Viewpoint region B in FIG. 7. Here, a three-dimensional view image displayed in a viewpoint region and a three-dimensional view image displayed in a user viewpoint position included in the viewpoint region are identical.

Furthermore, the three-dimensional image generation unit 201 holds (i) projected amount data generated for the three-dimensional view image seen from the first viewpoint, as first display information 202, and (ii) projected amount data generated for the three-dimensional view image seen from the second viewpoint as second display information 203.

Moreover, the three-dimensional image generation unit 201 (i) performs processing associated with the predetermined operation determined by the operation determination unit 205 on the three-dimensional view image in the viewpoint region associated with the pointer and (ii) outputs the processed image to the display 105.

As an example of the processing performed on the three-dimensional view image, when the operation determination unit 205 determines that an operation to “select” an arbitrary portion of the three-dimensional view image is performed, the three-dimensional image generation unit 201 performs processing (changing the color, flashing, changing the brightness, or highlighting) on the three-dimensional view image in the viewpoint region associated with the pointer to allow the user to perceive that the position over which the pointer is placed is selected.

As another example of the processing on the three-dimensional view image, when the operation determination unit 205 determines that an operation to “rotate” the three-dimensional view image is performed, the three-dimensional image generation unit 201 performs processing (generating images with different angles in order) on the three-dimensional view image in the viewpoint region associated with the pointer so that the three-dimensional view image rotates in the moving direction of the pointer.

The user position finger coordinate calculation unit 204 which serves as the detection unit detects the pointer from the corresponding one of the viewpoint regions. More specifically, the user position finger coordinate calculation unit 204 receives the video signal obtained by the camera 4 via the input and output IF unit 101. Furthermore, the user position finger coordinate calculation unit 204 performs image processing such as pattern matching on this video signal. This pattern matching is image processing for extracting user viewpoint position and image of the hand of the user.

Specifically, the user position finger coordinate calculation unit 204 calculates the position of the user as two-dimensional coordinate values from the video area shown by the video signal using a facial recognition technology. For example, the position of the user is identified by the two-dimensional coordinate values (x, y) having the origin at the center of the video area. Then, the user position finger coordinate calculation unit 204 calculates, as viewing angle information, a user viewpoint position (θ) based on the x coordinate of the position of the user. In order to simplify processing described later, as shown in FIG. 8, x coordinates in the right of the center of the video area are represented by negative values, while x coordinates in the left of the center of the video area are represented by positive values.

In other words, the user β operating from the right with respect to the display 105 is in the left in the video area captured by the camera 4, as shown in FIG. 8. The x coordinate of the two-dimensional coordinate values (x, y) of the user β is represented by a positive value (namely 80, in the example in FIG. 8. Hereinafter, (i) the user viewpoint position of the user α viewing from the front is defined as being at 0 degree, (ii) the user viewpoint position of the user β viewing from the right with respect to the display 105 is defined from 0 degree to 90 degrees, and (iii) the user viewpoint position of a user (not shown in the drawing) viewing from the left with respect to the display 105 is defined from 0 degree to negative 90 degrees.

Assuming that the camera 4 which can capture a wide angle, namely 180 degrees, is used and the scope of the coordinates of the position of the user that can be calculated as the two-dimensional coordinate values is from negative 160 degrees to 160 degrees, the user viewpoint position (θ) can be given by Expression 1.

$$\begin{matrix}[ Math 1 ] & \\ ( θ ) = ( \frac{x}{160} \times 90 ) & Expression 1\end{matrix}$$

In other words, in the example in FIG. 8, the user viewpoint position (θ) of the user α whose the x coordinate on the video area is 0 is 0 degree, while the user viewpoint position (θ) of the user β whose the x coordinate on the video area is 80 is 45 degrees.

Moreover, the user position finger coordinate calculation unit 204 calculates the position information of the hand of the user, as three-dimensional coordinate values (x, y, z) having an origin at the center of the display surface in the real space, by performing image matching processing using a preliminarily prepared template indicating a form of a hand or the like from the video area shown by a video signal. The methods for calculating the three-dimensional coordinates include: a method for obtaining three-dimensional coordinates of a target point using a stereo camera; and a method for obtaining a distance to the target point by a camera called distance image camera which uses infrared rays.

Moreover, the user position finger coordinate calculation unit 204 uniquely associates the calculated user viewpoint position (β) with the position information of the hand of the user. Specifically, the user position finger coordinate calculation unit 204 performs the image matching processing using a preliminarily prepared template indicating the form of neck, torso, arm, hand, and the like, based on the user viewpoint position (β). Thus, the user position finger coordinate calculation unit 204 creates a form of a human model based on the identified user viewpoint position (θ), and associates the user viewpoint position (θ) with the position information of the hand of the user.

The operation determination unit 205 determines a predetermined operation based on the movement of the pointer detected by the user position finger coordinate calculation unit 204.

As an example of the predetermined operation, when the pointer is placed over an arbitrary position of the three-dimensional view image in the viewpoint region associated with the pointer, the operation determination unit 205 determines that the operation is to “select” the position. Meanwhile, even when the pointer is placed over a three-dimensional view image in another viewpoint region, the operation determination unit 205 does not determine that the operation is to “select” the image.

As another example of the predetermined operation, when a pointer moves in an arbitrary direction at a position facing the three-dimensional view image in the viewpoint region associated with the pointer, the operation determination unit 205 determines that the operation is to “rotate” the three-dimensional view image. Meanwhile, even when the pointer moves at a position facing a three-dimensional view image in another viewpoint region, the operation determination unit 205 does not determine that the operation is to “rotate” the image.

More specifically, the operation determination unit 205 obtains the user viewpoint positions of one or more users and the position information of one or more hands of the user, which are calculated by the user position finger coordinate calculation unit 204, and obtains the display information (projected amount data) associated with the user viewpoint position from the first display information 202 or the second display information 203 in the three-dimensional image generation unit 201. Then, the operation determination unit 205 compares the obtained display information (projected amount data) and the obtained position information of the hand associated with the user viewpoint position, and determines whether or not operations such as to “select” the three-dimensional view image has been performed.

Specifically, the operation determination unit 205 obtains the position information (x0, y0, z0) of the hand associated with the user viewpoint position (0 degree) from the user position finger coordinate calculation unit 204, and obtains the first display information 202, as the display information associated with the user viewpoint position (0 degree), from the three-dimensional image generation unit 201. Moreover, the operation determination unit 205 compares the projected amount data of the three-dimensional view image that is held in the first display information 202 and the position information of the hand (x0, y0, z0). When the operation determination unit 205 determines that the hand of the user is in contact with the border of the three-dimensional view image as a result of the comparison, the operation determination unit 205 determines that the operation to “select” the three-dimensional view image has been performed by the user.

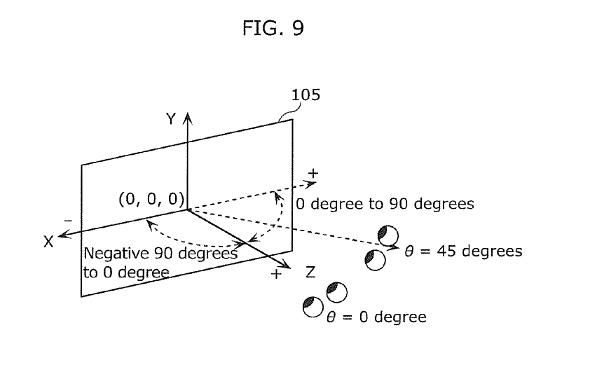

FIG. 9 shows three-dimensional coordinate system in the real space. FIG. 9 shows the coordinate system having the origin at the center of the display 105 and being represented in distance (cm), and the central coordinates (xc, yx, zc) of the coordinate system are represented by (0, 0, 0). Assuming that X axis extends in a horizontal direction on a display surface of the display 105, X coordinates have positive values in the right of the center of the display 105 and negative values in the left of the center of the display 105 when it is seen from the viewpoint region of the user. Furthermore, assuming that Y axis extends in a vertical direction on a display surface of the display 105, Y coordinates have positive values on the upper portion of the center of the display 105 and negative values in the lower portion of the display 105 when it is seen from the viewpoint region of the user. Moreover, assuming that Z axis extends perpendicular to the XY plane, Z coordinates have positive values in a direction of the viewpoint region of the user from the display surface of the display 105 and negative values in a depth direction from the display surface of the display 105 that is the direction opposite to the viewpoint region of the user. In other words, the three-dimensional view image is projected outward with respect to the display surface when the Z coordinate has a positive value, while projected inward with respect to the display surface when the Z coordinate has a negative value.

Furthermore, as to the user viewpoint position (θ), a user viewpoint position (θ) of a user viewing from a position with a positive X coordinate value is represented by a value from 0 degree to 90 degrees. Meanwhile, a user viewpoint position (θ) of a user viewing from a position with a negative coordinate value is represented by a value from 0 degree to negative 90 degrees.

In this coordinate system, coordinates can be uniquely defined regardless of the viewpoint position of the user, and therefore the same coordinate system is used for both of the user viewpoint position (0 degree) and the user viewpoint position (45 degrees).

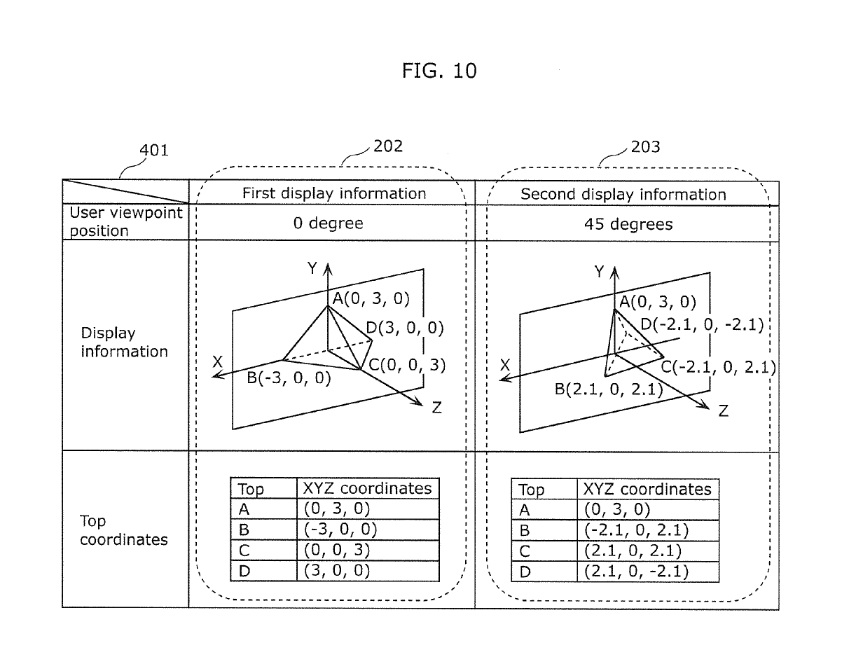

FIG. 10 describes a display information table 401 which indicates display information held by the three-dimensional image generation unit 201 as the first display information 202 and the second display information 203. The display information table 401 includes the first display information 202 and the second display information 203 which are generated by the three-dimensional image generation unit 201 upon generating a three-dimensional view image. Each piece of display information (broad sense) includes user viewpoint position, display information (narrow sense), and top coordinates.

The first display information 202 shown in FIG. 10 is display information of the triangular pyramid displayed in Viewpoint region A (user α at a user viewpoint position (0 degree)). The triangular pyramid identified based on the first display information 202 is a triangular pyramid having the top projected outward the farthest from the display surface of the display 105 at the position of the three-dimensional coordinate values (0, 0, 3).

Specifically, a value of 0 degree is stored as the user viewpoint position information in the first display information 202. Furthermore, the display information associated with the user viewpoint position (0 degree) is stored in the first display information 202. The display information is related to the three-dimensional view image which is virtually drawn in the computer using three-dimensional object data called polygon data or texture data, such as the three dimensional computer graphics (CG). Moreover, in the first display information 202, the projected amount of the triangular pyramid seen from the user viewpoint position (0 degree) is recorded as the top coordinates.

The second display information 203 shown in FIG. 10 is display information of the triangular pyramid displayed in Viewpoint region B (user β at a user viewpoint position (45 degrees)). The triangular pyramid identified based on the second display information 203 appears as the identical triangular pyramid seen from the user α at the user viewpoint position (0 degree).

Specifically, a value of 45 degrees is stored in the user viewpoint position information of the second display information 203. Furthermore, the display information associated with the user viewpoint position (45 degrees) is stored in the display information in the second display information 203. For example, in the display information in the second display information 203, display information indicating a three-dimensional view image, obtained by rotating the three-dimensional view image which is indicated by the first display information 202, by (θ)=45° with taking Y axis as a center, is stored. Specifically, the projected amount data (X, Y, Z) in the second display information 203 can be calculated by applying matrix transform represented by Expression 2 to the projected amount data (x, y, z) in the first display information 202.

$$\begin{matrix}[ Math 2 ] & \\ ( X , Y , Z ) = ( \begin{matrix}cos θ & 0 & sin θ \\ 0 & 1 & 0 \\ - sin θ & 0 & cos θ\end{matrix} ) ( \begin{matrix}x \\ y \\ z\end{matrix} ) & Expression 2\end{matrix}$$

Moreover, in the second display information 203, the projected amount of the triangular pyramid seen from the user viewpoint position (45 degrees) is recorded.

By displaying the three-dimensional view image, which is identified based on the first display information 202 and the second display information 203, on the display 105 which can be used as a naked-eye multi-viewpoint display, the user α at the user viewpoint position (0 degree) and the user β at the user viewpoint position (45 degrees) can share the identical triangular pyramid.

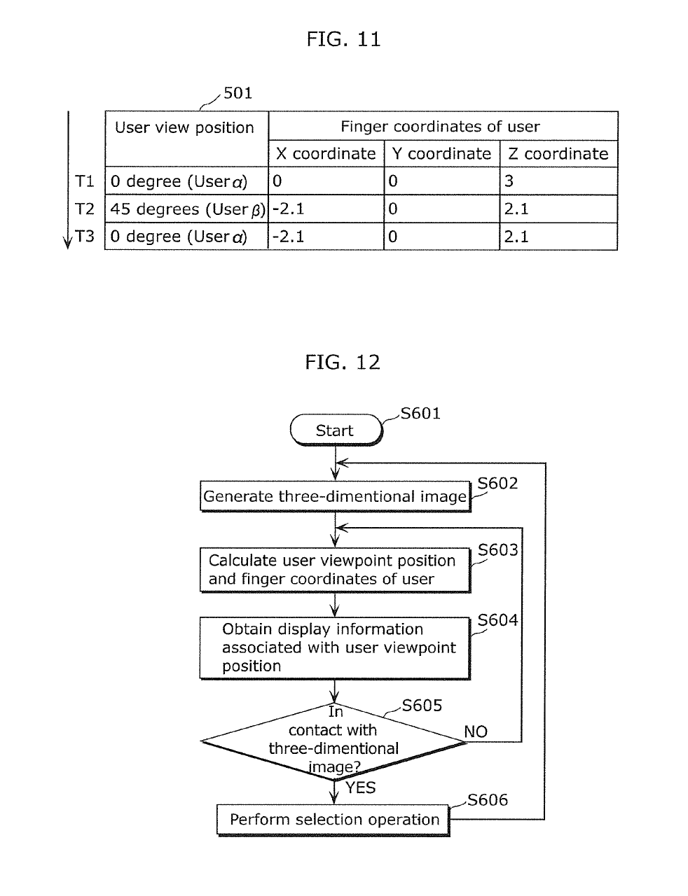

FIG. 11 is an example of an output result 501, which is obtained by uniquely associating the user viewpoint position (θ) and the position information of the hand of the user calculated as the three-dimensional coordinate values (x, y, z) on the real space. The association is performed by the user position finger coordinate calculation unit 204.

In the example in FIG. 11, as the result of the calculation by the user position finger coordinate calculation unit 204 at Time T1, (i) the user α at the user viewpoint position (0 degree) and (ii) the finger coordinates as the three-dimensional coordinate values of the user a (0, 0, 3) are calculated. Furthermore, as the result of the calculation by the user position finger coordinate calculation unit 204 at Time T2 that is after Time T1, (i) the user β at the user viewpoint position (45 degrees) and (ii) the finger coordinates as the three-dimensional coordinate values of the user β (−2.1, 0, 2.1) are calculated. Moreover, as the result of the calculation by the user position finger coordinate calculation unit 204 at Time T3 that is after Time T2, (i) the user α at the user viewpoint position (0 degree) and (ii) the finger coordinates as the three-dimensional coordinate values of the user α (−2.1, 0, 2.1) are calculated.

The following describes a case where the content of the display information table 401 is displayed on the display 105 which can be used as a naked-eye multi-viewpoint display, and (i) the user α at the user viewpoint position (0 degree) and (ii) the finger coordinates as the three-dimensional coordinate values of the user α (0, 0, 3) are calculated as the result of the calculation by the user position finger coordinate calculation unit 204 at Time T1. At this time, the operation determination unit 205 compares (i) the top coordinates in the first display information 202 associated with the user viewpoint position (0 degree) and (ii) the calculation result of the user position finger coordinate calculation unit 204 at Time T1.

Specifically, the operation determination unit 205 performs contact determination by determining whether or not the finger coordinates as the three-dimensional coordinate values of the user a (0, 0, 3) overlap with the top coordinates in the first display information 202. When the finger coordinates of the user as the three-dimensional coordinate values are represented as (xu, yu, zu), the top coordinates of the three-dimensional view image associated with the finger coordinates are represented as (xv, yv, zv), and the distance between the finger coordinates of the user and the top coordinates is smaller than or equal to L (L is a value greater than or equal to 0), the operation determination unit 205 applies Expression 3 for determining that the hand of the user has contacted the top of the three-dimensional view image. In other words, when Expression 3 is satisfied, the operation determination unit 205 determines that the hand of the user has contacted (is placed over) the top of the three-dimensional view image.

[Math 3]

\sqrt{(xu−xv)²+(yu−yv)²+(zu−zv)²}≦L Expression 3

For example, when determining that the hand of the user has contacted the top of the three-dimensional view image under the condition that Distance L is 0, the operation determination unit 205 performs the contact determination by applying Expression 3 on (i) all of the top coordinates A, B, C, and D in the first display information 202 and (ii) the finger coordinates of the user (0, 0, 3). In this example, Top C satisfies Expression 3. Therefore, the operation determination unit 205 determines that the hand of the user at the user viewpoint position (0 degree) has contacted Top C.

Next, the following describes a case where (i) the user β at the user viewpoint position (45 degrees) and (ii) the finger coordinates of the user β as the three-dimensional coordinate values (−2.1, 0, 2.1) are calculated, as the calculation result of the user position finger coordinate calculation unit 204 at Time T2. At this time, the operation determination unit 205 performs the similar contact determination as performed at Time T1 above, by comparing (i) the top coordinates in the second display information 203 associated with the user viewpoint position (45 degrees) and (ii) the calculation result of the user position finger coordinate calculation unit 204 at Time T2.

Next, the following describes regarding a case where (i) the user α at the user viewpoint position (0 degree) and (ii) the finger coordinates of the user α s the three-dimensional coordinate values (−2.1, 0, 2.1) are calculated, as the calculation result of the user position finger coordinate calculation unit 204 at Time T3. The finger coordinates of the user α as the three-dimensional coordinate values (−2.1, 0, 2.1) superimpose on Top C of the three-dimensional view image displayed in Viewpoint region B. In other words, the user a at the user viewpoint position (0 degree) is pointing a finger over the three-dimensional view image in Viewpoint region B. Specifically, the user α at the user viewpoint position (0 degree) is pointing in space where nothing is displayed (user a sees nothing).

In this case also, the operation determination unit 205 performs the similar contact determination as performed at Time T1 above, by comparing (i) the top coordinates in the first display information 202 associated with the user viewpoint position (0 degree) and (ii) the calculation result of the user position finger coordinate calculation unit 204 at Time T3.

When Distance L in Expression 3 is 0, a top which satisfies the condition of Expression 3 is not found. Therefore, the operation determination unit 205 can determine that the hand of the user α is not contact with the top of the three-dimensional view image. Specifically, errors, such as selection operation on a three-dimensional view image in another viewpoint, do not occur even when the user α t the user viewpoint position (0 degree) points a finger over the position where the three-dimensional view image for the user β at the user viewpoint position (45 degrees) is displayed. As a result, a desired operation in association with the user viewpoint position can be realized.

Although the above example describes the case where Distance L in Expression 3 is 0, a value greater than or equal to 0 may be used. In other words, it goes without saying that any value which allows determining that the hand of the user is in contact with (placed over) the top of the three-dimensional view image may be used.

Furthermore, contact determination based on whether the hand of the user has contacted a side or a surface constituting the three-dimensional view image may be performed, instead of the contact determination based on the distance between the finger coordinates of the user and the top coordinates. In other words, any methods may be adopted as long as it can be recognized that the finger of the user is in contact with the three-dimensional view image based on the finger coordinates.

Furthermore, although the user position finger coordinate calculation unit 204 outputs (i) the user viewpoint position (θ) and (ii) the position information of the hand of the user calculated as the three-dimensional coordinate values (x, y, z) in the real space of one of the users at each of the times (T1, T2, and T3), the user viewpoint position (θ) and the position information of the hand of the user of the two users may be output at a same time. In other words, (i) the information of the user α at the user viewpoint position (0 degree) at Time T1 and (ii) the information of the user β at the user viewpoint position (45 degrees) at Time T2 may be output at the same Time T1.

FIG. 12 is a flowchart showing an example of the processing, performed by the signal processing unit 102 according to the present embodiment, for accepting the selection operation by the user. The following describes, for convenience in description, an operation performed when an application is started via the touch panel 2.

The touch panel 2 accepts an operation by the user and transmits a signal for starting the application to the input and output IF unit 101. For example, the user taps an icon for starting the application displayed on the display 105. Next, upon receiving the signal for starting the application via the input and output IF unit 101, the signal processing unit 102 transmits a power ON signal to the camera 4 via the input and output IF unit 101. Upon receiving the power ON signal, the camera 4 starts start-up, and starts capturing the user after executing initialization and the like. Then, the camera 4 outputs the video signal obtained in the capturing to the user position finger coordinate calculation unit 204 via the input and output IF unit 101 (S601).

Moreover, upon receiving the signal for starting the application, the signal processing unit 102 directs the three-dimensional image generation unit 201 to generate each of three-dimensional view images for a corresponding one of the viewpoint areas. After accepting the direction from the signal processing unit 102, the three-dimensional image generation unit 201 reads the three-dimensional object data such as polygon data or texture data stored in the flash memory 104.

Then, the three-dimensional image generation unit 201 (i) calculates, based on the read three-dimensional object data, the display information and the top coordinates associated with Viewpoint region A (user viewpoint position (0 degree)) and (ii) holds the display information and the top coordinates as the first display information 202, and concurrently, (iii) generates the three-dimensional view image in association with Viewpoint region A (user viewpoint position (0 degree)) and (iv) causes the display 105 which can be used as a naked-eye multi-viewpoint display to display the generated three-dimensional view image.

Moreover, the three-dimensional image generation unit 201 (i) calculates, based on the first display information 202 and by a conversion equation such as matrix transform (Expression 2, for example), the display information and the top coordinates associated with Viewpoint region B (user viewpoint position (45 degrees)) and (ii) holds the display information and the top coordinates as the second display information 203, and concurrently, (iii) generates the three-dimensional view image associated with Viewpoint region B (user viewpoint position (45 degrees)) and (iv) causes the display 105 which can be used as a naked-eye multi-viewpoint display to display the generated three-dimensional view image (S602).

Next, the user position finger coordinate calculation unit 204 continuously receives the video signal transmitted from the camera 4, via the input and output IF unit 101. The user position finger coordinate calculation unit 204 signal-processes the received video signal, and calculates the user viewpoint position and the three-dimensional coordinate values which are the position information of the hand of the user (S603).

The user position finger coordinate calculation unit 204 outputs, to the operation determination unit 205, the calculated user viewpoint position and the three-dimensional coordinate values which are the position information of the hand of the user. It is to be noted that the user position finger coordinate calculation unit 204 sequentially executes the image-processing on the video signal received continuously, and continuously outputs, to the operation determination unit 205, the user viewpoint position which is the result of the image-processing and the three-dimensional coordinate values which is the position information of the hand of the user.

The operation determination unit 205 obtains, from the display information table 401 held by the three-dimensional image generation unit 201, the display information associated with the user viewpoint position continuously outputted from the user position finger coordinate calculation unit 204 (S604).

The operation determination unit 205 compares the top coordinates in the display information obtained in the step S604 and the three-dimensional coordinate values which are the position information of the user associated with the user viewpoint position, and performs the contact determination. When the operation determination unit 205 determines that the hand of the user is not in contact with the three-dimensional view image associated with the hand of the user as a result of the determination, the step returns to the step S603. Meanwhile, when the operation determination unit 205 determines that the hand of the user is in contact with the three-dimensional view image associated with the hand of the user, the step proceeds to the step S606 (S605).

When determining that the hand of the user is in contact with the three-dimensional view image associated with the hand of the user in the step S605, the operation determination unit 205 notifies that the user is performing the selection operation on the three-dimensional view image to the three-dimensional image generation unit 201. In other words, when the operation determination unit 205 determines that the finger of the user α is in contact with any of the top of the three-dimensional view image based on the three-dimensional coordinate values that are the position information of the hand of the user α at a user viewpoint position (0 degree), the operation determination unit 205 directs the three-dimensional image generation unit 201 to add a display which allows the user α to clearly determine that the three-dimensional view image is selected, to the display information in the first display information 202 (S606). It is to be noted that “display which allows the user to clearly determine that the three-dimensional view image is selected” may include, for example, changing the color of, flashing, changing the brightness of, or highlighting the selected top.

The operation determination unit 205 directs the three-dimensional image generation unit 201 to add the display which allows the user α to clearly determine that the three-dimensional view image is selected, to the display information in the first display information 202, when the operation determination unit 205 determines that the finger of the user α is in contact with any of the top of the three-dimensional view image based on the three-dimensional coordinate values that are the position information of the hand of the user α at a user viewpoint position (0 degree)) in the step S606. However, it is sufficient that the operation determination unit 205 directs the three-dimensional image generation unit 201 to add the display to the three-dimensional view image which allows the user α to clearly determine that the three-dimensional view image is selected.

The three-dimensional image generation unit 201 may allow both of the user α at the user viewpoint position (0 degree) and the user β at the user viewpoint position (45 degrees) to share the three-dimensional view image added with the display which allows the users to clearly determine that the three-dimensional view image is selected. In other words, the three-dimensional image generation unit 201 may perform the processing for the operation performed on the three-dimensional view image in Viewpoint region A, not only on the three-dimensional view image in Viewpoint region A, but also on three-dimensional view images in Viewpoint regions B to E.

The tablet apparatus 1 according to Embodiment 1 includes a naked-eye multi-viewpoint display and displays a three-dimensional view image which can be space-operated from a plurality of viewpoints. This tablet apparatus 1 includes: a three-dimensional image generation unit 201 which generates three-dimensional images for viewpoints; a user position finger coordinate calculation unit 204 which calculates viewpoint positions of the users who perform space-operation and the finger coordinate positions of the users indicated in the three-dimensional coordinates; and an operation determination unit 205 which determines the space-operation performed by the users on the three-dimensional view images, and performs operations associated with the viewpoint positions of the users.

Thus, the tablet apparatus 1 can perform the operation in association with the user at each viewpoint, when users space-operate the three-dimensional view images displayed on the naked-eye multi-viewpoint display. Accordingly, the operability of the tablet apparatus 1 is improved.

Although Embodiment 1 has been described, the present invention is not determined by the above example.

In other words, although Embodiment 1 describes the operation determination by the operation determination unit 205 based on only one example which is “selection” operation, it goes without saying that the present invention can be applied to any operation performed on the three-dimensional view image, such as moving, expanding, contracting, and rotating the three-dimensional view image.

For example, the operation determination unit 205 determines, as the “rotation” operation, movement of a hand in an arbitrary direction that is perpendicular to a line connecting the three-dimensional view image and the user, at a position facing the three-dimensional view image. In this case, it is sufficient for the three-dimensional image generation unit 201 to rotate the three-dimensional view image in the direction of the movement of the hand.

Furthermore, the operation determination unit 205 determines, as the “expansion operation (movement of the hand in a further direction from the three-dimensional view image)” or the “contraction operation (movement of the hand in a closer direction to the three-dimensional view image)”, movement of the hand in a direction parallel to a line connecting the three-dimensional view image and the user at a position facing the three-dimensional view image. In this case, it is sufficient for the three-dimensional image generation unit 201 to expand or contract the three-dimensional view image according to the moving amount of the hand.

Here, when the user β in Viewpoint region B in FIG. 7 tries to perform the above rotation operation when it is seen with taking the display 105 as a reference, it appears that the hand of the user β moves from the near left (upper-right in FIG. 7) in a direction in the far right (lower-left in FIG. 7). Therefore, when the operation determination unit 205 tries to determine the operation by the user with taking the display 105 as a reference, the operation determination unit 205 may make an erroneous determination on whether the above operation is the rotation operation or expanding/contracting operation.

Therefore, the operation determination unit 205 according to Embodiment 1 determines the operation by the user with taking the positional relationship between the three-dimensional video associated with each of the viewpoint regions and the hand of the user. As a result, the erroneous determination as the above can be effectively prevented.

Furthermore, although Embodiment 1 shows the example where the user position finger coordinate calculation unit 204 calculates only one set of three-dimensional coordinate values (x, y, z) in the real space for one viewpoint region (user viewpoint position), a plurality of sets of the three-dimensional coordinate values (x, y, z) in the real space may be calculated for one viewpoint region (user viewpoint position). For example, the user position finger coordinate calculation unit 204 may calculate two sets of, namely a position of a thumb and a position of an index finger, three-dimensional coordinate values in the real space for one user viewpoint position, by performing an image-processing with higher accuracy and recognizing the position of the thumb and the position of an index finger separately.

Thus, in addition to the operation such as selection, the tablet apparatus 1 can realize a more complex operation such as to “cull” the three-dimensional view image displayed for three-dimensional view. Accordingly, users can perform more operations and a greater convenience can be provided for the users.

Furthermore, although the tablet apparatus 1 according to Embodiment 1 includes the camera 4 and the display 105, the camera 4 and the display 105 are not necessary constituents for the three-dimensional image processing apparatus. In other words, the three-dimensional image processing apparatus may correspond to the signal processing unit 102 in FIG. 6, and may be configured to obtain video from an external camera 4 and output a three-dimensional view image to an external display 105.

Furthermore, although Embodiment 1 shows only one example where the identical three-dimensional view images are displayed in a plurality of user viewpoint positions, a different three-dimensional view image may be displayed in each of the user viewpoint positions.

Thus, an advantageous effect is provided that even when a plurality of users use the tablet apparatus 1 concurrently, each user can view different three-dimensional view content.

### Embodiment 2

Embodiment 2 describes examples of usage of the tablet apparatus 1 described in Embodiment 1 more specifically. The tablet apparatus 1 according to Embodiment 2 includes the similar constituents as the tablet apparatus 1 according to Embodiment 1.

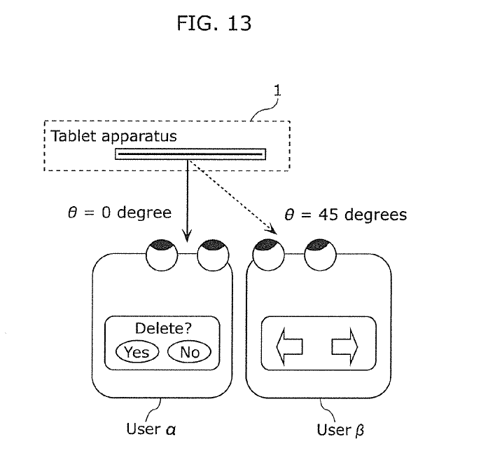

FIG. 13 shows a usage example of the tablet apparatus according to Embodiment 2. An example described in Embodiment is an operation performed in a case where a different three-dimensional view image is displayed for a user viewpoint position (0 degree) and a user viewpoint position (45 degrees). For example, when the tablet apparatus 1 is set on a wall at a public facility or the like and is applied for use by a plurality of users, such as digital signage, the tablet apparatus 1 can provide advantageous effects such as an advertisement can be offered effectively by displaying a different three-dimensional view image for each user (each viewpoint region).

For example, deletion confirmation message dialogue for use in deleting content being viewed is displayed as a three-dimensional view image for the user α at the user viewpoint position (0 degree), and the top coordinates of the three-dimensional view image are stored in the first display information 202. Furthermore, arrow buttons for use in selecting right or left is displayed as a three-dimensional view image for the user β at the user viewpoint position (45 degrees), and the top coordinates of the three-dimensional view image are stored in the second display information 203.

In Embodiment 2, for convenience, it is assumed that the top coordinates of “Yes” button of the deletion confirmation message dialogue and the top coordinates of the “left arrow button” for selecting right or left are the same, and the top coordinates of “No” button of the deletion confirmation message dialogue and the top coordinates of the “right arrow button” for selecting right or left are the same.

When the user α at the user viewpoint position (0 degree) presses the “No” button, the operation determination unit 205 performs the contact determination using (i) the top coordinates in the first display information 202 in the display information table 401 held by the three-dimensional image generation unit 201 and (ii) the three-dimensional coordinate values which are the position coordinates of the hand of the user α at the user viewpoint position (0 degree). As a result, the operation determination unit 205 determines that the hand of the user α at the user viewpoint position (0 degree) has contacted the “No” button, and notifies the determination result to the three-dimensional image generation unit 201.

After obtaining the determination result of the operation determination unit 205, according to the direction (press of “No” button) by the user α at the user viewpoint position (0 degree), the three-dimensional image generation unit 201 does not delete the content or the like but changes the screen. For example, the three-dimensional image generation unit 201 continues to display the video of the content.

In the same manner, when the user β at the user viewpoint position (45 degrees) presses the “left arrow button”, the operation determination unit 205 performs the contact determination using (i) the top coordinates in the second display information 203 in the display information table 401 held by the three-dimensional image generation unit 201 and (ii) the three-dimensional coordinate values which are the position coordinates of the hand of the user β at the user viewpoint position (45 degrees). As a result, the operation determination unit 205 determines that the hand of the user β has contacted the “left arrow button”, and notifies the determination result to the three-dimensional image generation unit 201.

After obtaining the determination result of the operation determination unit 205, according to the direction (press of “left arrow button”) by the user β at the user viewpoint position (45 degrees), the three-dimensional image generation unit 201 changes the screen. For example, the three-dimensional image generation unit 201 scrolls map information being displayed to the left.

In the tablet apparatus 1 having the above configuration, even when the user β at the user viewpoint position (45 degrees) places a finger over the position of the “Yes” button being displayed for the user α at the user viewpoint position (0 degree), the content the user α at the user viewpoint position (0 degree) is viewing is not deleted. In other words, the operation of the user β at the user viewpoint position (45 degrees) is determined as the operation to press the “left arrow button” being displayed for the user β at the user viewpoint position (45 degrees). As a result, an operation in association with the user at each viewpoint can be realized. Accordingly, the operability of the tablet apparatus 1 is improved and a more effective display can be provided.

Although the tablet apparatus 1 which is an example of the three-dimensional image processing apparatus has been described based on embodiments, the present invention is not determined by these embodiments. Other forms in which various modifications apparent to those skilled in the art are applied to the embodiments, or forms structured by combining constituents in the embodiments are included in the present invention.

For example, processing performed by a specific processing unit may be processed by another processing unit. Furthermore, the order of performing processing may be changed, and a plurality of processing may be executed in parallel.

Furthermore, the present invention can be realized not only as the three-dimensional image processing apparatus but also as a method including processing units constituting the three-dimensional image processing apparatus as steps. For example, these steps are executed by a computer. Furthermore, the present invention can be realized as a program for causing a computer to execute the steps included in the method. Moreover, the present invention can be realized as a computer-readable recording medium for use in a computer, such as a CD-ROM.

In other words, the three-dimensional image generation method according to an aspect of the present invention is a method for causing a display apparatus to display a three-dimensional image, the display apparatus being capable of separately displaying a plurality of three-dimensional images, the three-dimensional image processing method includes: outputting a plurality of three-dimensional images to the display apparatus; detecting a pointer in association with a three-dimensional image displayed on the display apparatus; determining a predetermined operation based on movement of the pointer detected in the detecting; and performing, on the three-dimensional image associated with the pointer, processing associated with the predetermined operation determined in the determining, and causing the processed three-dimensional image to be output in the outputting.

Furthermore, a program according to an aspect of the present invention is for causing a computer to cause a display apparatus to display a three-dimensional image, the display apparatus being capable of separately displaying a plurality of three-dimensional images, the program includes: outputting a plurality of three-dimensional images to the display apparatus; detecting a pointer in association with a three-dimensional image displayed on the display apparatus; determining a predetermined operation based on movement of the pointer detected in the detecting; and performing, on the three-dimensional image in association with the pointer, processing associated with the predetermined operation determined in the determining, and causing the processed three-dimensional image to be output in the outputting.

Furthermore, constituents included in the three-dimensional image processing apparatus may be configured from a single System-LSI (Large-Scale Integration). These constituents may be separately integrated into one chip, or may be integrated into one chip to include a part or all of the constituents. For example, constituents other than the memory units may be integrated into one chip. The name used here is LSI, however, it may also be called integrated circuit (IC), LSI, super LSI, or ultra LSI depending on the difference in the degree of integration.

Furthermore, ways to achieve integration are not limited to the LSI, and the integration may be achieved by a dedicated circuit or a general purpose processor and so forth. Field Programmable Gate Array (FPGA) that can be programmed after manufacturing LSIs or a reconfigurable processor that allows re-configuration of the connection or setting of an LSI can also be used.

Furthermore, with advancement in semiconductor technology or a different technology derived from the semiconductor technology, a brand-new technology for forming integration circuits may replace LSI. It goes without saying that the constituents included in the three-dimensional image processing apparatus can be formed into an integrated circuit using such a technology.

Furthermore, in the process of forming the integrated circuit, only one unit storing data out of a plurality of functional blocks may be another configuration without integrating the unit into the configuration for integrating into one chip.

Each of the above embodiment and modification examples may be combined.

Although the embodiment of the present invention has been described with reference to the drawings, the present invention is not determined by the embodiment illustrated. Various modifications or variation may be added to the above embodiment in the scope equal to the present invention or in the scope of equality.

### INDUSTRIAL APPLICABILITY

The three-dimensional image processing apparatus according to the present invention makes it possible to space-operate each of three-dimensional view images for the corresponding one of viewpoint positions, and therefore applicable to a tablet apparatus, a TV, a digital camera, a personal computer, and a camera-equipped mobile phone.

1. A three-dimensional image processing apparatus which causes a display apparatus to display a three-dimensional image, the display apparatus being capable of separately displaying a plurality of three-dimensional images, the apparatus comprising:
an output unit configured to output a plurality of three-dimensional images to the display apparatus;
a detection unit configured to detect a pointer in association with a three-dimensional image displayed on the display apparatus;
an operation determination unit configured to determine a predetermined operation based on movement of the pointer detected by the detection unit; and
an image processing unit configured to perform, on the three-dimensional image associated with the pointer, processing associated with the predetermined operation determined by the operation determination unit, and to cause the output unit to output the processed three-dimensional image.

2. The three-dimensional processing apparatus according to claim 1,
wherein the operation determination unit is configured to determine, as the predetermined operation, placement of the pointer over an arbitrary position in the three-dimensional image associated with the pointer, and
the image processing unit is configured to perform processing on the three-dimensional image associated with the pointer to allow a user to perceive that the position over which the pointer is placed is selected.

3. The three-dimensional image processing apparatus according to claim 1,
wherein the operation determination unit is configured to determine, as the predetermined operation, movement of the pointer in an arbitrary direction at a position facing the three-dimensional image associated with the pointer, and
the image processing unit is configured to perform processing on the three-dimensional image associated with the pointer so that the three-dimensional image rotates in a direction of the movement of the pointer.

4. The three-dimensional image processing apparatus according to claim 1,
wherein the display apparatus displays a plurality of identical three-dimensional images, and
the image processing unit is further configured to perform the processing associated with the predetermined operation determined by the operation determination unit on the three-dimensional image other than the three-dimensional image associated with the pointer, and to cause the output unit to output the processed three-dimensional images.

5. The three-dimensional image processing apparatus according to claim 1,
wherein the display apparatus is capable of separately displaying each of the three-dimensional images in a corresponding one of a plurality of viewpoint regions,
the output unit is configured to output each of the three-dimensional images for the corresponding one of the viewpoint regions to the display unit, and
the detection unit is configured to detect the pointer from each of the viewpoint regions and associate the detected pointer with the three-dimensional image in the viewpoint region from which the pointer is detected.

6. A three-dimensional image processing method for causing a display apparatus to display a three-dimensional image, the display apparatus being capable of separately displaying a plurality of three-dimensional images, the method comprising:
outputting a plurality of three-dimensional images to the display apparatus;
detecting a pointer in association with a three-dimensional image displayed on the display apparatus;
determining a predetermined operation based on movement of the pointer detected in the detecting; and
performing, on the three-dimensional image associated with the pointer, processing associated with the predetermined operation determined in the determining, and causing the processed three-dimensional image to be output in the outputting.

7. A program for causing a computer to cause a display apparatus to display a three-dimensional image, the display apparatus being capable of separately displaying a plurality of three-dimensional images, the program comprising:
outputting a plurality of three-dimensional images to the display apparatus;
detecting a pointer in association with a three-dimensional image displayed on the display apparatus;
determining a predetermined operation based on movement of the pointer detected in the detecting; and
performing, on the three-dimensional image in association with the pointer, processing associated with the predetermined operation determined in the determining, and causing the processed three-dimensional image to be output in the outputting.
